(19) United States
(12) Patent Application Publication
(10) Pub. No.: US 2004/0053641 A1
(43) Pub. Date: Mar. 18, 2004

(54) System and method for delivery to multiple units

(75) Inventors: Grant Leung, Toronto (CA); Randal Palach, Toronto (CA); John Stevens, Toronto (CA); Mike Vandenberg, Toronto (CA); Paul Waterhouse, Toronto (CA)

Correspondence Address: McGinn & Gibb, PLLC, Suite 200, 8321 Old Courthouse Road, Vienna, VA, 22182-3817, US

(73) Assignee: eBox, Inc., Toronto (CA)

(21) Appl. No.: 10/385,513

(22) Filed: Mar. 12, 2003

Related U.S. Application Data
(60) Provisional application No. 60/363,241, filed on Mar. 12, 2002.

(51) Int. Cl. H04M 1/00

(52) U.S. Cl. 455/558; 455/73

(57) ABSTRACT

A system for delivery to multiple units includes a drop-box array including a plurality of drop-boxes and at least one transceiver, and an access device which includes a second transceiver, for wirelessly communicating with the at least one transceiver to access a drop-box.

### CROSS REFERENCE TO RELATED APPLICATIONS

This Application claims priority from U.S. Provisional Application No. 60/363,241 entitled “SYSTEM AND METHOD FOR DELIVERY TO MULTIPLE UNITS”, which was filed on Mar. 12, 2002, assigned to the present assignee, and is incorporated herein by reference.

### BACKGROUND OF THE INVENTION

1. Field of the Invention

The present invention relates to a system and method for delivery to multiple units, and in particular, a system and method for delivery to multiple units which utilize a drop-box array.

2. Description of the Related Art

One of the major problems in high-rise buildings especially condominiums and apartment buildings is delivering packages and courier envelopes which require proof of delivery (POD). In most cases a deliveryman must obtain access to the lobby, and can do so only if he has a key to an entrance door, or if the building has a 24-hour concierge at a desk in the lobby. Once the delivery person is in the lobby they have the difficult task of obtaining the signature of the person to receive the package.

In some cases, a concierge is allowed to sign and in other cases, the concierge must locate the person. In about 40 percent of the cases, the person is not home and a deliveryman must leave a card indicating that he was there and was unable to leave the package, so that the person can call a special number to arrange a time and in some cases a place to pickup the package. Alternatively, the card may direct the person to a special location where they can pick up the package. This process is called “carding”, and leads to significant additional expense for the delivery person as well as inconvenience for the recipient of the package.

Alternatively, an array of boxes may be placed either in the lobby, or outside the building in the back, where the deliveryman could leave packages for an individual. However, if the apartment building contains 100 or more residents, such a box array would have to be very large. In addition the boxes must be large enough to hold the largest package possible, even though often the item delivered may be only a small envelope. Therefore, such a drop box approach is not cost-effective for delivery of packages and other courier items requiring proof of delivery.

In another alternative, variable-size drop boxes may be placed either in the lobby or outside the building that have numbers or labels placed on the outside. Because such drop boxes have variable dimensions, the deliveryman can place the package in a box that matches the package size. The deliveryman would then leave a card with the number of the box either in the person's mailbox or with the concierge. The person may go to the box and open the correct door. However, such conventional systems are complicated and do not provide the shipper with a clear proof of delivery (POD).

### SUMMARY OF THE INVENTION

In view of the foregoing and other problems, disadvantages, and drawbacks of the conventional methods and structures, an object of the present invention is to provide a system and method for delivery to multiple units which conserves space, and which is inexpensive to operate.

The present invention includes a system for delivery to multiple units. The inventive system includes a drop-box array including a plurality of drop-boxes and at least one transceiver, and an access device including a second transceiver, for wirelessly communicating with the at least one transceiver to access a drop-box in the array.

Specifically, the at least one transceiver may include a plurality of transceivers, each transceiver being associated with a drop-box in the plurality of drop-boxes. On the other hand, the at least one transceiver may include a transceiver which is associated with all drop-boxes in the array.

The drop-box may include a locking mechanism for locking a door of the drop-box, and an indicating device (e.g., a light emitting diode) for visually indicating the drop-box. For example, the indicating device may be activated to indicate which drop-box in the drop-box array is to receive a delivery item.

The access device may include, for example, a handheld delivery device for accessing a drop-box in order to deliver an item. The access device may also include an access card for accessing a drop box in order to remove a delivered item therefrom.

The system may also include a controller (e.g., computer system) for controlling an operation (e.g., opening and closing of doors to the drop-boxes) in the drop-box array. For example, the at least one transceiver may wirelessly communicate with the controller. In addition, the controller may wirelessly receive an instruction from the access device, select a drop-box for receiving an item, and cause a door of the selected drop-box to open. Further, the controller may include a memory device for storing information (e.g., time and date of opening of a drop-box) pertaining to the plurality of drop-boxes.

In addition, the access device may also include a multifunctional device having at least one function (e.g., a building security function) unrelated to the drop-box array. In addition, the drop-box array may include at least two differently-sized drop-boxes.

The present invention also includes an inventive method of delivering to multiple units. The inventive method includes selecting a drop-box in a drop-box array for receiving a delivery item, and using an access device to wirelessly communicate with the drop-box array, in order to open the selected drop-box.

Further, the present invention includes a programmable storage medium tangibly embodying a program of machine-readable instructions executable by a digital processing apparatus to perform the inventive method.

With its unique and novel aspects, the claimed invention provides a system and method for delivery to multiple units which conserves space, is inexpensive to operate, and is able to maintain accurate delivery information and proof of delivery.

### BRIEF DESCRIPTION OF THE DRAWINGS

The foregoing and other purposes, aspects and advantages will be better understood from the following detailed description of a preferred embodiment of the invention with reference to the drawings, in which:

FIG. 1 illustrates the inventive system 100 for delivery to multiple units according to the present invention;

FIG. 2A provides a detailed illustration a drop-box 115 and access device 120 which may be used in the inventive system 100;

FIG. 2B illustrates a second example of the drop-box 115 and access device 120 having a keypad 122, according to the present invention;

FIG. 3A is a block diagram of a first control circuit 194 that may be included in the inventive system 100 according to the present invention;

FIG. 3B is a block diagram of an second control circuit 195 that may be included in the inventive system 100 according to the present invention;

FIG. 4 illustrates an controller 150 which may be used in the inventive system 100 according to the present invention;

FIG. 5 provides an illustration of how a software system 500 at a distribution center may communicate with a handheld device 120 according to the present invention;

FIG. 6 provides an illustration of how a phone link 152 may be used to link the drop box array 110 to the software system 500 at a distribution center according to the present invention; and

FIG. 7 is a flow chart illustrating an inventive method 700 for delivery to multiple units, in accordance with the present invention.

### DETAILED DESCRIPTION OF THE PREFERRED EMBODIMENTS

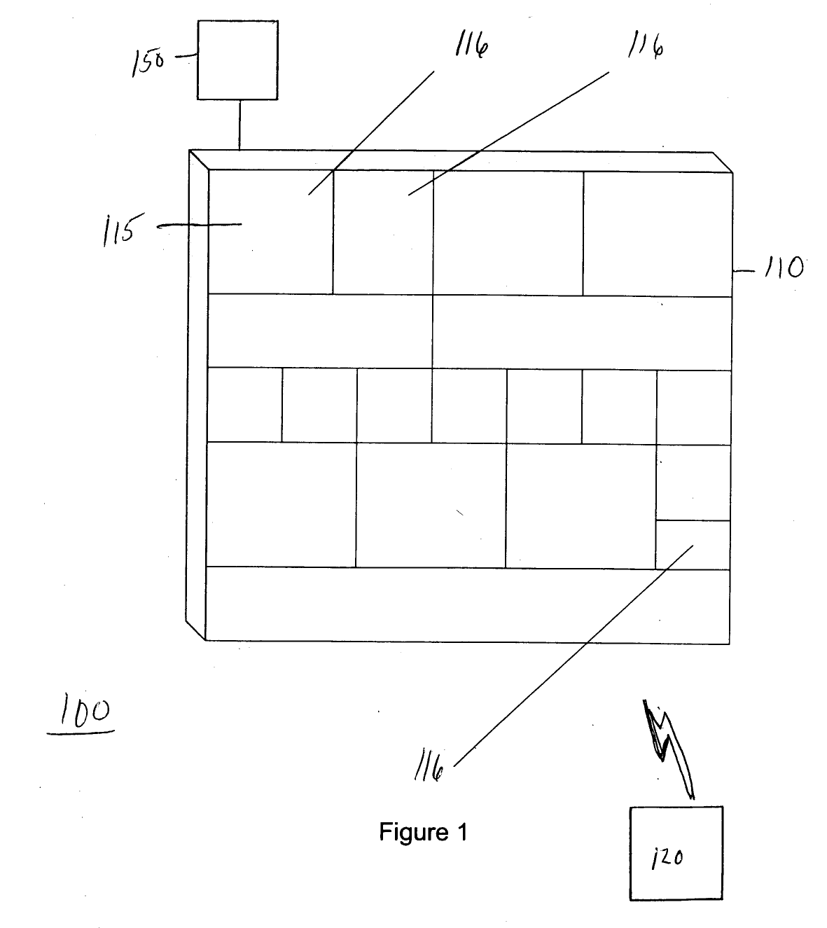

Referring now to the drawings, FIG. 1 illustrates an inventive system 100 for multiple unit delivery according to the claimed invention.

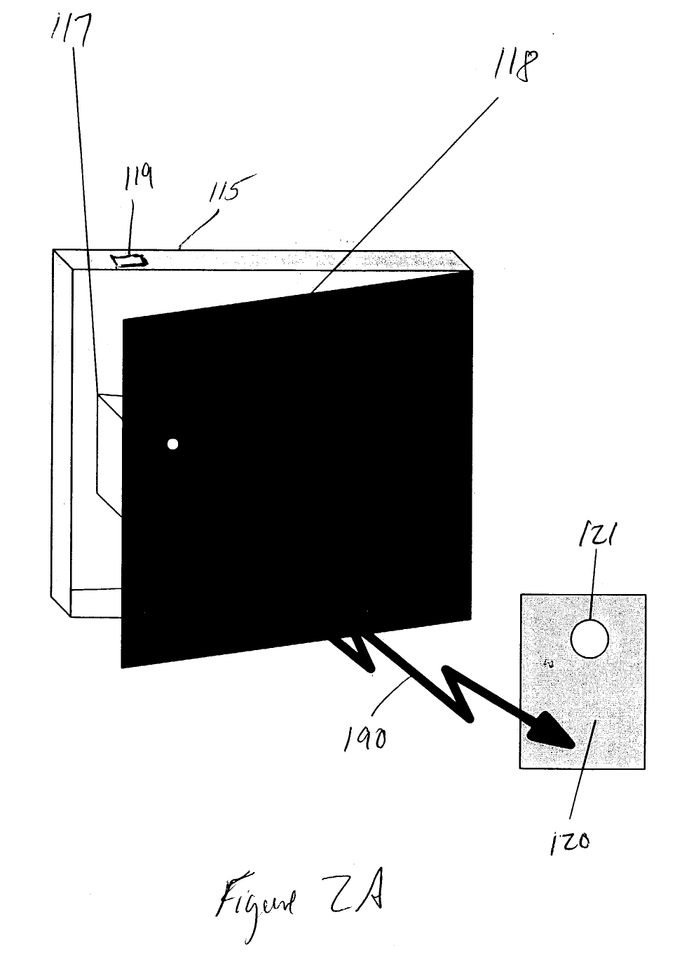

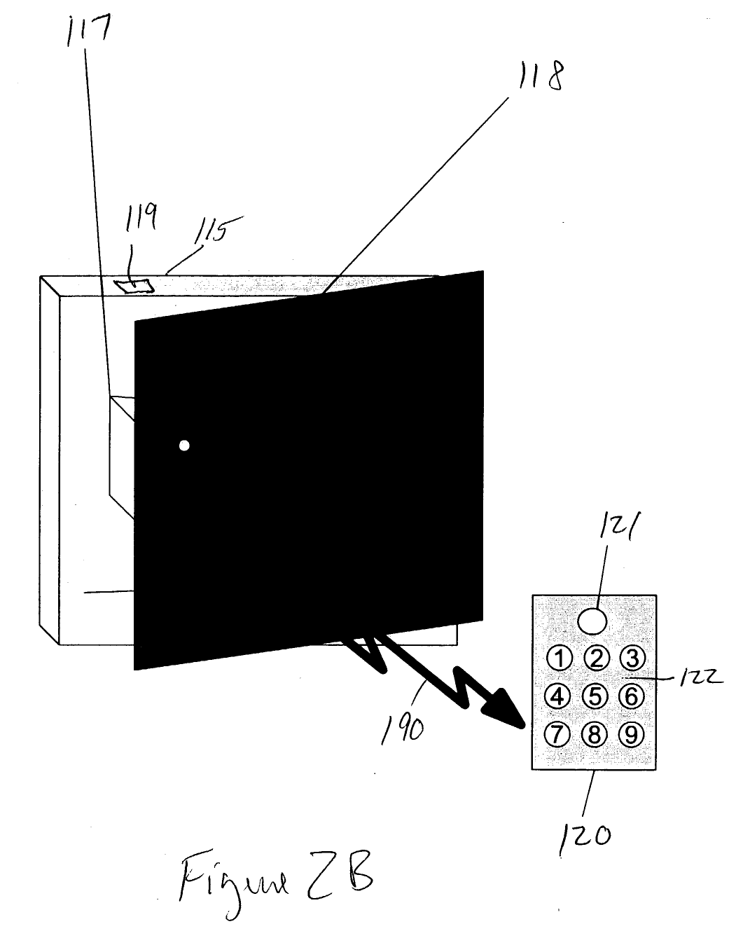

As shown in FIG. 1, the inventive system 100 includes a drop-box array 110 having a plurality of drop-boxes 115, and an access device 120, for wirelessly communicating with a drop-box in the array in order to open the door 116 of the drop-box. As shown in FIG. 1, the drop-boxes 115 may also have varying sizes to efficiently accommodate different size packages. Further, as shown in FIGS. 2A-2B, the drop-box 115 may include an electronic locking mechanism 117 and an indicating device 118 (e.g., a visual indicating device such as a light emitting device (e.g., light emitting diode (LED)) located on the door 116).

The drop-box 115 may also include a transceiver 119 for wirelessly communicating with the access device 120, so that the drop-box may be controlled by a wireless two-way link to the electronic access device 120. Alternatively, the drop-box 110 may include a transceiver connected to the controller 150 for wirelessly controlling all of the drop-boxes in the array 110.

The inventive system 100 may also include a controller 150 (e.g., microprocessor, computer system, etc.) which is connected (e.g., wirelessly or hard-wired) to the drop-box array 110. The controller 150 may control an operation of the drop-box array 115, for example, by determining which drop-box 115 is to be used to deliver a particular item.

The access device 120 may include a two-way wireless point circuitry, and a battery, with small inexpensive four-bit microprocessor and memory. For instance, the memory may include programmable read-only memory (PROM) which may store, for example, a unique identification (ID) number. In addition, as shown in FIG. 2B, the access device 120 may optionally include a keypad in order to enter a personal identification number (PIN).

The access device 120 may include, for example, an access card which may be used to place a delivery item in the drop-box (e.g., by a delivery person), and remove a delivery item from the drop-box (e.g., by the person to whom the package was addressed). For instance, the access device 120 may include a small handheld delivery device which may be used, for example, by a deliveryman to access a drop-box in order to deliver an item.

Further, the access device 120 may include an access card which may be used to open the door to the drop-box to take possession of a delivered item. For example, each resident of a building may get such an access card (e.g., with a unique identification (ID) number corresponding to a customer ID) which allows the resident to access a drop-box array located, for example, in the lobby of the building.

Thus, for example, an apartment building may have a drop-box array consisting of multiple (e.g., 10, 20 etc.) boxes of different sizes. When the deliveryman arrives with the package, the deliveryman enters the customer ID number into a handheld delivery device, and pushes an entry button on the handheld delivery device to program the controller 150 (e.g., the pod computer for the array 110). The controller 150 (e.g., computer) then directs a drop-box that can hold the package to turn on the drop-box light-emitting device (e.g., LED), and directs the locking mechanism on the door of that particular drop-box to unlock.

Further, the selection of the drop-box may be pre-programmed into the handheld delivery device, for instance, at the warehouse before the deliveryman starts the route. For example, the customer ID number (or some other identifying number) may be placed on the package as a readable number, or with a bar-code. The handheld delivery device may also include a bar-code reader making entry of the ID number simple.

Furthermore, the deliveryman may use the handheld delivery device to program the pod computer (e.g., controller 115) so that the drop-box with the package may be opened by a resident using a access card without the need for an ID number. Alternatively, the handheld delivery device may program the pod computer (e.g,. controller 115) for a specific access card and a unique PIN number.

Further, the PIN number may be fixed for a period of time and associated with a specific access card and a specific customer, similar to that used by an automated teller machine (ATM). The computer may also be programmed for a onetime use PIN number, that either the customer has selected or the shipper has selected, but to which both have agreed.

For example, the customer may be notified (e.g., via phone, e-mail, or card from the concierge) that an item has arrived and is in the drop-box array 110. The customer may then take his access card to the drop-box array 110, press the button on the access card, and the box containing the customer's package will flash its LED. The customer may go over to that specific drop-box, open the door, remove the item, and close the door.

The pod computer (e.g., controller 150) may record the time the box was opened and closed, as well as all details associated with the customer's access card. If the handheld delivery device programs the pod computer (e.g., controller 150) for a PIN number, then the customer must also enter the correct PIN number for the box to unlock and the LED to flash. In other words, the customer removing the item must have the physical card, and the PIN number in order to access the box. This provides the shipper as well as the delivery company a proof of delivery record which is as reliable as any ATM transaction record.

Alternatively, the access device may include data stored in the form of a magnetic media on the surface of the card (e.g, a magnetic swipe card). In this case, for example, a keypad would be affixed to drop-box array, so that the customer may swipe his card and enter a PIN number on the keypad in order to access a drop-box. In fact, the inventive system 100 may include only a keypad which does not include a wireless or magnetic swipe card.

One advantage of the inventive system 100 is that it has the advantage of not requiring a wired link back to the main computer database (e.g,. at a distribution center) from the drop-box array 110. Alternatively, a link (e.g., via a phone line) from the drop-box array 110 to the computer (e.g., at the distribution center) may be optionally installed, for example, in order to facilitate customer returns. For example, the customer may want to return the delivered item to the manufacturer or shipper. The customer may phone the manufacturer or shipper to obtain authorization for the return. The link from the computer (e.g., a the distribution center) to the drop-box array 110 could, therefore, be used to program a drop-box to accept the item to be returned. Therefore, the customer may use his access card to identify the proper drop-box (e.g, via flashing LED) and unlock the designated drop-box in order to insert the item to be returned.

In addition, the access device (e.g., access card or handheld delivery device) may be a multipurpose device which may additionally be used, for example, for purposes unrelated to the drop-box. For example, the system 100 may be coordinated with building security, so that the delivery man may use the handheld delivery device to gain entrance to the lobby of the building. (e.g., the delivery man may enter a PIN number unique to him which causes a lobby door to open) and then use the same handheld device to open a drop-box in the array 110 to deliver an item.

Further, information pertaining to such other uses of the handheld device (e.g., the date and time of entry into lobby, etc.) may be stored by the system in a memory device (e.g., database) to provide detailed records on the item delivered. For instance, such information could be harvested by the handheld delivery device in order to provide proof of entry into the lobby and proof of delivery of the item.

Similarly, coordinating the system 100 with other systems (e.g., building security) would allow the customers to use the access card for other uses unrelated to the drop-box array 110. For instance, tenants of a condo or apartment complex could use the access card for entry into the lobby, pool, parking garage, etc..

More specifically, FIG. 1 illustrates the inventive system 100 having a drop box array 110. As shown in FIG. 1, each drop-box 115 may have a door 116 that may open independent of the other doors. Further, the drop-boxes 115 may have a variety of dimensions and no identifying marks numbers are necessary on the doors which helps to conceal the fact that valuable delivery items may be stored in the drop-boxes.

Each door 116 may include a locking mechanism 117 and an indicating device (e.g., a small light emitting device (e.g., LED)) 118 placed, for example, near the locking mechanism. Thus, each door has its own independent lock.

The drop-box array 110 may be placed, for example, in the lobby of a condominium apartment building or office building. Further, FIG. 1 shows a drop-box array 110 with 18 independent drop-boxes (e.g., compartments), although this is merely exemplary and should not be construed as limiting in any way.

FIG. 2A provides a detailed illustration a drop-box 115 which may be used in the inventive system 100. As shown in FIG. 2A, the locking mechanism 117 may be placed near a center of the door 116 and the indicating device 118 (e.g., a small LED) may be placed over the locking mechanism 117. Further, an access device 120 may wirelessly communicate (e.g., via a two-way wireless link 190) with the drop-box 115 (e.g., the transciever 119), causing the indicating device 118 to activate (e.g., light up) and causing the locking mechanism 117 to unlock.

As shown in FIG. 2A, the access device 120 may include an access card having a single button 121 (e.g., switch) that the customer may engage to access the drop-box 115. The locking mechanism 117 may be he directly wired (e.g., hard-wired) to the controller 150. The controller 150 may then wirelessly communicate with an access device 120 so that the controller 150 can make the decision based on the access card ID number which drop-box 115 should be opened.

Specifically, the controller may cause an LED on the selected drop-box 115 to activate so that the customer knows which drop-box to open to obtain the delivered item. Further, the door 116 may also have a magnetic hold, so that the customer may actually push the door 116 first, in order to open the door. However the locking mechanism 117 should be in the open position for the door to swing through the open position.

FIG. 2B illustrates another example of the drop-box 115 and access device 120. Specifically, in cases where a higher level of security is required, and clear proof of delivery is required, the access device 120 may include a keypad 122 in addition to the button 121 for opening the door 116. For example, the controller 150 may be programmed to require a specific PIN number to be entered on the keypad 122 in order for a customer to access the drop-box 115. Further, the PIN number may be fixed and not change from delivery to delivery, or it may optionally be a onetime use PIN for very high security deliveries. For example, where very high security is desired, the PIN number may be communicated to the customer via phone, e-mail or even regular mail.

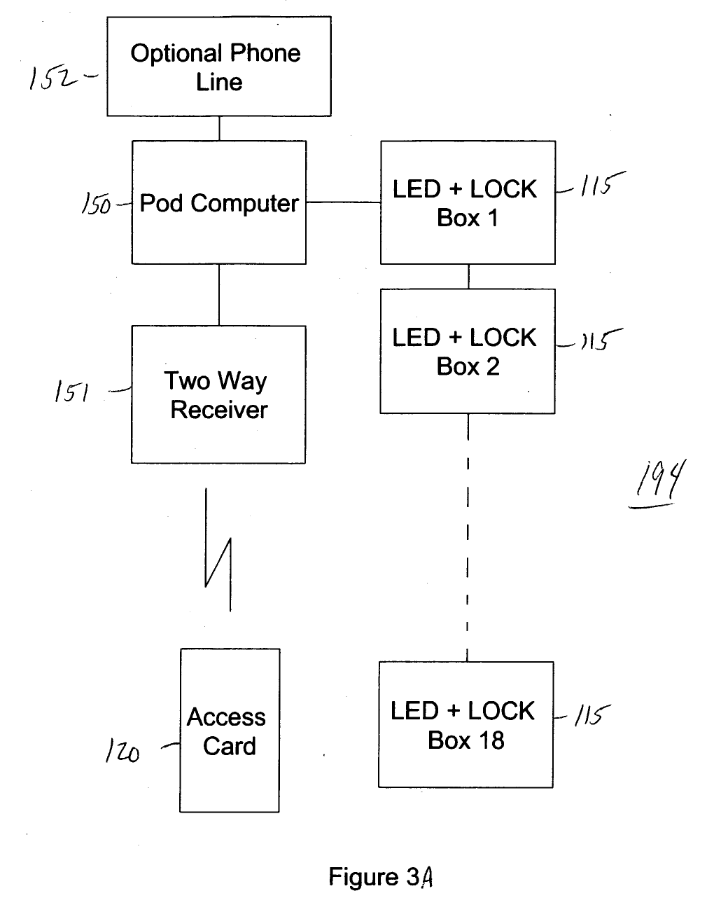

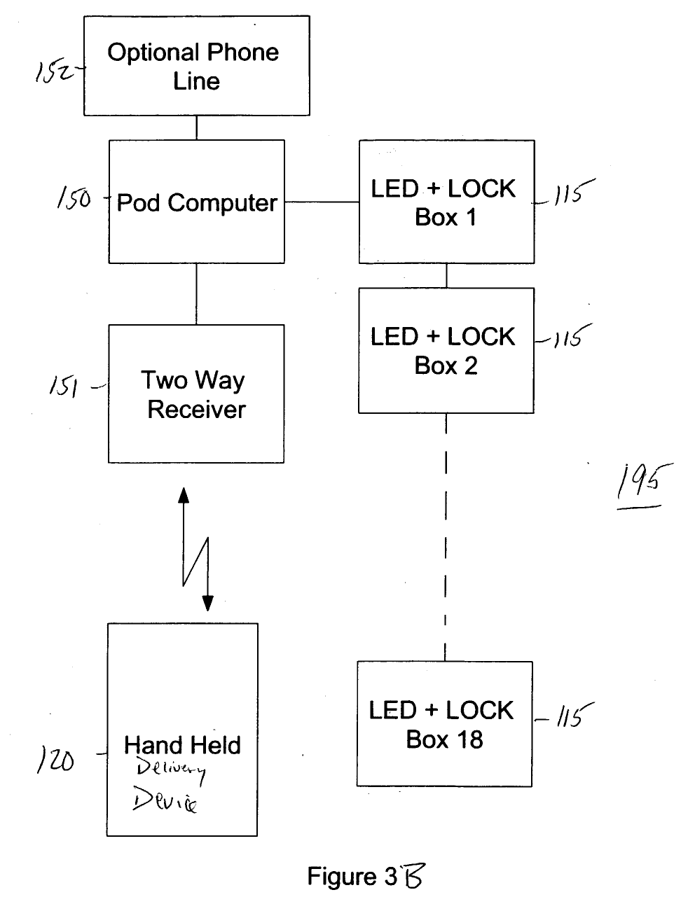

FIG. 3A is a block diagram of a first control circuit 194 that may be included in the inventive system 100. As shown in FIG. 3A, the controller 150 (e.g., pod computer) may be connected to the drop-box indicating devices 118 (e.g., LEDs) and locking mechanisms 117. This connection may be connected via a wire (e.g., hard-wire), that transmits, for example, information identifying a drop-box number, locking mechanism number, indicating device number, etc..

Alternatively, the controller 150 may be connected to the LEDs and locking mechanisms via a wireless link, similar to the wireless link used by the access devices 120 (e.g., an access card) to communicate with the drop-box. In addition, the controller 150 (e.g., pod computer) may be connected directly to a two-way receiver 151 (e.g., transceiver) and antenna to communicate with the access card 120. In this case, for example, the access device 120 may be used to wirelessly communicate with the receiver 151 in order to open all of the drop-boxes in the array 110.

Further, as shown in FIG. 3A, the controller 150 (e.g., pod computer) may be connected to a phone line 152 so that the controller 150 can easily communicate to a central control system such as a distribution center (not shown) which may coordinate a control of several individual systems at several buildings. For example, the phone line 152 would be particularly useful to communicate to a central computer the status of the drop-boxes 115, such as whether a delivered item has been removed, or if the item remains in the drop-box. The controller 150 (e.g., pod computer) may optionally dial out on this line periodically (e.g., every hour to two hours) to obtain and transmit data associated to with a status of the system 100.

The phone line 152 may also be useful to allow a third party (e.g., a secondary delivery agent) to use the drop-box array 110 in addition to a primary delivery agent. In this case, the primary delivery agent would like to know when the third party has placed an item in the box prior to leaving the distribution center for deliveries. In addition, using the phone line connection 152, the controller 150 (e.g., pod computer) can dial out to the central control system if a third party has placed an item in a particular drop-box number. This would enable the central control system to schedule the primary delivery agent drop-boxes and package matches.

FIG. 3B is a block diagram of a second control circuit 195 that may be included in the inventive system 100. As shown in FIG. 3B, a handheld delivery device 120 may be used by the delivery person to open a drop-box 115 in order to deliver an item, or, for example, to pickup an item to be returned by the customer. The handheld delivery device 120 may be pre-programmed at the warehouse, for example, with a user ID number, and other detailed information required to deliver an item to the drop box array 110.

In addition, the handheld delivery device 120 may harvest the data that is contained in the controller 150 (e.g., pod computer). For example, data may be harvested pertaining to transactions over a certain previous time period (e.g., 24 hours). A typical handheld delivery device 120 may include, for example, a full function keypad with additional buttons and an display device (e.g., liquid crystal display (LCD)). Thus, a deliveryman can identify the address ID (usually a four digit number and the recipient's name) on the item to be delivered.

For example, the address ID (e.g., four digit number) may be entered into the handheld delivery device 120 as a key. The handheld delivery device 120 may transmit this information to the controller 150 (e.g., pod computer) via the two-way wireless link. Alternatively, the item to be delivered may have a bar-code printed on the waybill or placed directly on the package.

The handheld delivery device 120 may also have an optional bar-code reader that is used to scan the bar-code on the item to identify the item, for example, by a user ID. The handheld delivery device 120 may transmit this information to the controller 150 (e.g., pod computer) which identifies a drop-box 115 capable of holding the item, unlocks the locking mechanism 117, and activates the indicating device (e.g., LED) 118).

Therefore, the deliveryman may go to the drop-box 115 with the flashing LED, open it, and place the item in the drop-box 115 and close the door 116. Thus, the handheld delivery device 120 may serve several functions, including giving the deliveryman control and access to the drop-box, and capturing a data log from the drop-box to check for proof of delivery, for example, from the previous day. In addition, a phone line may be connected to the controller 150 (e.g., pod computer) in order to transmit data logs and also pre-programmed drop-box information (e.g., location of drop-box, etc.).

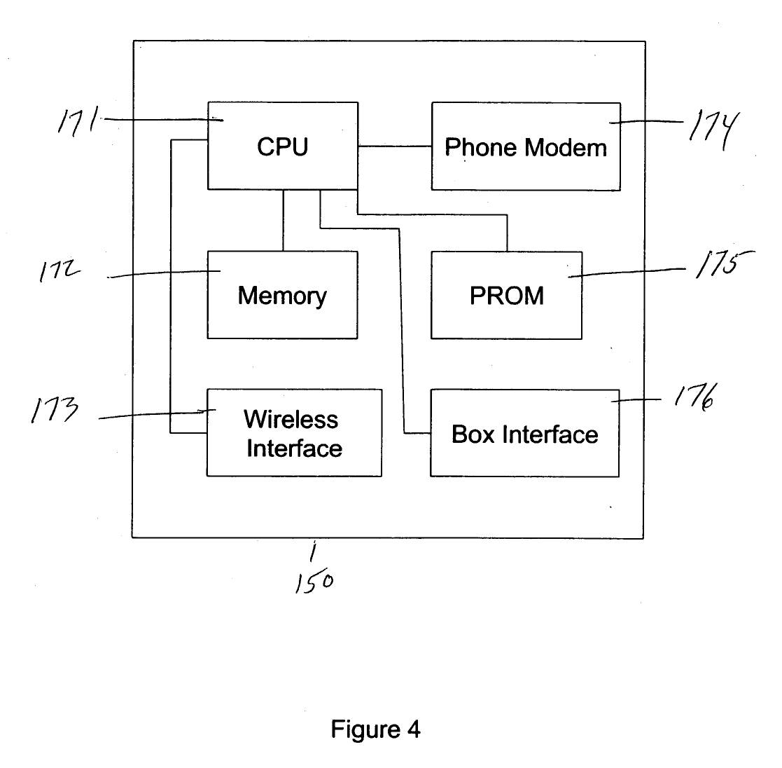

FIG. 4 provides a detailed illustration of a controller 150 which may be used in the inventive system 100 according to the present invention. As shown in FIG. 4, the controller 150 may include a central processing unit (CPU) 171 (e.g., microprocessor), a memory device 172 (e.g., random access memory (RAM) or read-only memory (ROM)), a wireless interface 173, a phone modem 174 (e.g., to connect with a central control system), a programmable read-only memory (PROM) 175 and drop-box interface 176 for interfacing with a drop-box 115.

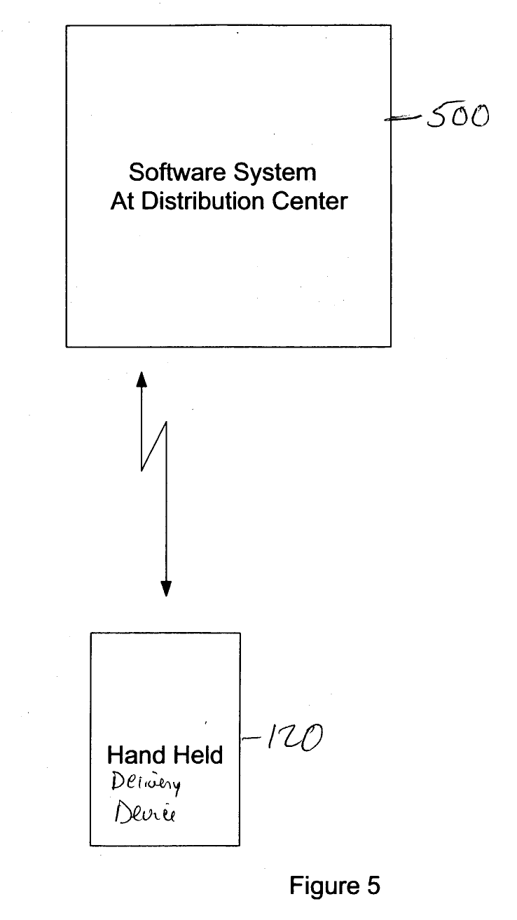

FIG. 5 provides an illustration of how a software system 500 at a distribution center may communicate with a handheld device 120 according to the present invention. For instance, when the delivery man returns to the distribution center at the end of a shift, the handheld delivery device 120 may be placed near a second two-way transmitter that communicates directly with the software systems 500. This enables the handheld delivery device 120 to be programmed for the next day's deliveries, as well as harvest all data logs used for proof of delivery. It also allows for programming of the security level for specific delivery items that may require, for example, entry of a PIN number in order to access a drop-box.

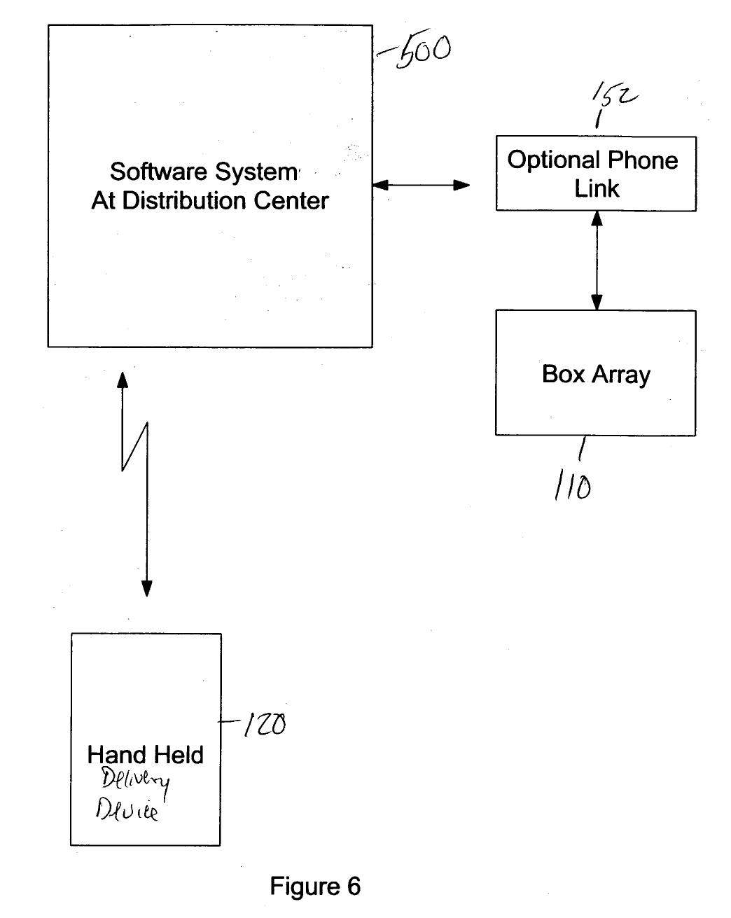

FIG. 6 provides an illustration of how a phone link 152 may be used to link the drop box array 110 to the software system 500 at a distribution center according to the present invention. As an alternative to direct links with the handheld delivery device the phone line 152 may also be used to communicate with the drop box array 110. This phone line 152 may optionally be replaced, for example, with a wireless cell phone link or data link using one of the cell phone networks. For example, the communication with the drop box array 110 may be carried out through the handheld delivery device 120 as a “network Courier system”. This concept (e.g., a network Courier system using a handheld delivery device 120 as a proxy for the phone line 152) may be economical.

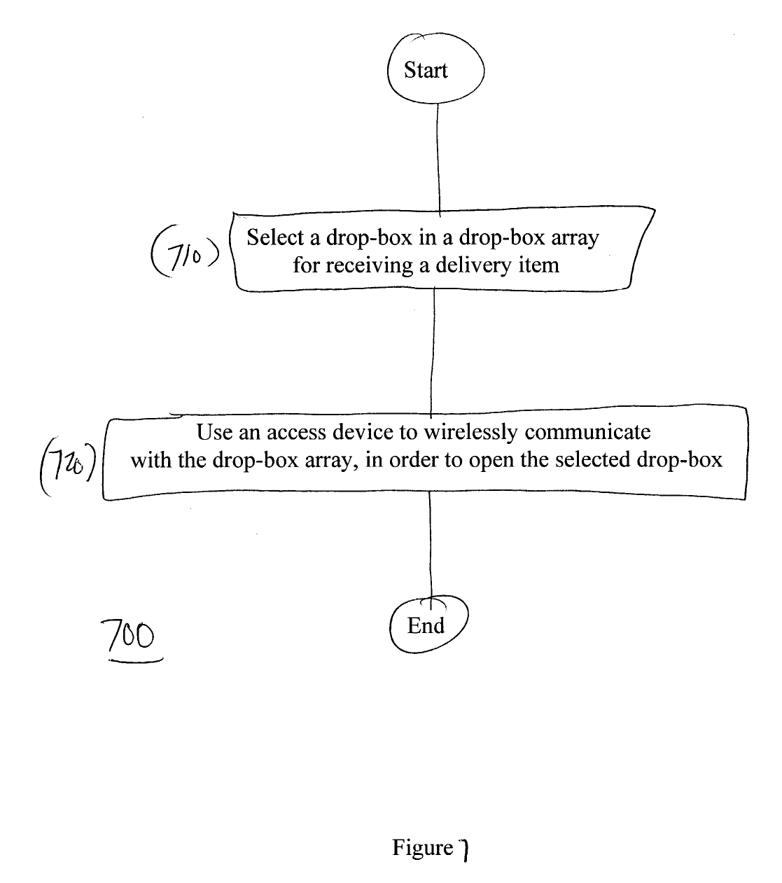

FIG. 7 is a flow chart illustrating an inventive method 700 for delivery to multiple units. As shown in FIG. 7, the inventive method 700 includes selecting (710) a drop-box in a drop-box array for receiving a delivery item, and using (720) an access device to wirelessly communicate with the drop-box array, in order to open the selected drop-box.

The present invention also includes a programmable storage medium tangibly embodying a program of machine-readable instructions executable by a digital processing apparatus to perform the inventive method.

With its unique and novel aspects, the claimed invention provides a system and method for delivery to multiple units which conserves space, is inexpensive to operate, and is able to maintain accurate delivery information and proof of delivery.

While a preferred embodiment of the present invention has been described above, it should be understood that it has been provided as an example only. Thus, those skilled in the art will recognize that the invention can be practiced with modification within the spirit and scope of the appended claims.

What we claim is:

1. A system for delivery to multiple units, comprising:
a drop-box array comprising a plurality of drop-boxes and at least one transceiver;
an access device comprising a second transceiver, for wirelessly communicating with said at least one transceiver to access a drop-box.

2. The system according to claim 1, wherein said at least one transceiver comprises a plurality of transceivers, each transceiver being associated with a drop-box in said plurality of drop-boxes.

3. The system according to claim 1, wherein said at least one transceiver comprises a transceiver which is associated with all drop-boxes in said array.

4. The system according to claim 1, wherein said drop-box comprises a locking mechanism for locking a door of said drop-box, and an indicating device for visually indicating said drop-box.

5. The system according to claim 4, wherein said indicating device is activated to indicate which drop-box in said drop-box array is to receive a delivery item.

6. The system according to claim 4, wherein said indicating device comprises a light emitting diode.

7. The system according to claim 1, wherein said access device comprises a handheld delivery device for accessing a drop-box in order to deliver an item.

8. The system according to claim 1, wherein said access device comprises an access card for accessing a drop box in order to remove a delivered item therefrom.

9. The system according to claim 1, further comprising:
a controller for controlling an operation of said drop-box array.

10. The system according to claim 9, wherein said controller comprises a computer system.

11. The system according to claim 9, wherein said at least one transceiver wirelessly communicates with said controller.

12. The system according to claim 9, wherein said controller wirelessly receives an instruction from said access device, selects a drop-box for receiving an item, and causes a door of the selected drop-box to open.

13. The system according to claim 9, wherein said controller comprises a memory device for storing information pertaining to said plurality of drop-boxes.

14. The system according to claim 11, wherein said information comprises time and date of opening of said drop-box.

15. The system according to claim 1, wherein said access device comprises a multifunctional device having at least one function unrelated to said drop-box array.

16. The system according to claim 1, wherein said plurality of drop-boxes comprises at least two differently-sized drop-boxes.

17. A method of delivering to multiple units, comprising:
selecting a drop-box in a drop-box array for receiving a delivery item; and
using an access device to wirelessly communicate with said drop-box array, to open said selected drop-box.

18. The method according to claim 17, wherein said selecting comprises selecting based on a size of said drop-box.

19. The method according to claim 17, wherein said using an access device comprises depressing a button on a handheld device to unlock said drop box.

20. A programmable storage medium tangibly embodying a program of machine-readable instructions executable by a digital processing apparatus to perform a method of delivering to multiple units, comprising:
selecting a drop-box in a drop-box array for receiving a delivery item; and
using an access device to wirelessly communicate with said drop-box array, to open said selected drop-box.
